(19) United States
(12) Patent Application Publication
(10) Pub. No.: US 2007/0236569 A1
(43) Pub. Date: Oct. 11, 2007

(54) Car-use camera

(75) Inventor: Shun-Fu Lin, Taipei (TW)

Correspondence Address: TROXELL LAW OFFICE PLLC;SUITE 1404, 5205 LEESBURG PIKE, FALLS CHURCH, VA, 22041, US

(73) Assignees: COLITEC Co., Ltd.; Shun-Fu LIN

(21) Appl. No.: 11/393,813

(22) Filed: Mar. 31, 2006

(51) Int. Cl. H04N 7/18; B60Q 1/00; G08G 1/14

(52) U.S. Cl. 348/148; 340/435; 340/932.2

(57) ABSTRACT

A car-use camera comprises: a monitor shell having a monitor lens on the outside thereof and a charge-coupled device on the inside thereof; and a motherboard shell having a motherboard having peripheral circuits on the inside thereof, wherein a transmission line is located to electrically connect the motherboard and the charge-coupled device and an image output line is additionally mounted on the motherboard. The large-sized motherboard is separable from the monitor shell so only the monitor shell located on the outside of the car body is affected by the heat. As a result, the lifetime of the car-use camera can be extended. Besides, only the monitor shell may be taken away when the car-use camera suffers from thievery. Consequently, the risk of being taken away can be reduced.

### FIELD OF THE INVENTION

The present invention relates to a car-use camera that has extended lifetime and reduced loss of thievery and that is suitable for all kinds of vehicles or the likes.

### BACKGROUND OF THE INVENTION

A general car is presently provided with a small-sized charge-coupled device (CCD) or complementary metal oxide semiconductor (CMOS) camera, which is worked with a display machine mounted inside the car, in addition to the general warning machines so as to enable a car driver to clearly know about the surroundings of the car, more particularly to know whether barriers, kids, or animals are located behind the car when backing. The CMOS camera provides the advantages of low cost, small size, and simple peripheral circuits so it can be miniaturized. However, the resolution of the CMOS camera is poor and the noise points appear easily. Besides, during the processing of images, the excessive-frequent current induces the problem of overheating. Furthermore, the CCD camera requires much more peripheral circuits so its motherboard has large size unavoidably. In other words, the CCD camera has large size even if it provides the advantage of good resolution. In view of these, the improvement made by the prevent invention is aimed at the CCD car-use camera.

Referring to FIG. 4 and FIG. 5, the conventional car-use camera is usually mounted on a car bumper 60, wherein the conventional car-use camera includes a shell 40, a monitor lens 41 on the shell 40, and a motherboard 42 having peripheral circuits 44 and a charge-coupled device 43 on the inside of the shell 40. After assembly, the motherboard 42 is mounted on the inside of the shell 40, which is integrated with the monitor lens 41. In other words, the motherboard 42 is integrated with the camera lens 41. In addition, the motherboard 42 and the monitor lens 41 are together mounted on the car bumper 60.

However, the car bumper 60, which is exposed to the outside of the car, is easily heated up when the car is parked on a place exposed to the sunlight sun. As a result, the car-use camera is also heated up to high temperature. However, the high temperature is bad for the motherboard 42 mounted inside the shell 40. In other words, the high temperature causes the captured images, which are outputted to the inside display machine of the car from the motherboard 42, to produce snow phenomenon. As a result, the problem of indistinct images is produced. Moreover, the high temperature reduces the lifetime of the motherboard 42 significantly when it is in high temperature condition over a long period of time.

In addition, the monitor lens 41 and the shell 40 that has the motherboard 42 may be taken away together by the thief when he destroys the car bumper 60 for stealing the car-use camera. As a result, the loss of the car owner is huge.

Moreover, the motherboard usually has large size so it is impossible to reduce the size of the conventional car-use camera. Consequently, it is not easy to assemble the car-use camera to the car bumper 60.

In view of the foregoing defects, the present, inventor makes diligent studies in providing consumers with a car-use camera that has extended lifetime and reduced loss of thievery according to the motive of the present invention.

### SUMMARY OF THE INVENTION

It is a main object of the present invention to provide a car-use camera that has extended lifetime and reduced loss of thievery.

In order to achieve the above-mentioned object, a car-use camera comprises: a monitor shell having a monitor lens on the outside thereof and a charge-coupled device on the inside thereof; and a motherboard shell having a motherboard having peripheral circuits on the inside thereof, wherein a transmission line is located to electrically connect the motherboard and the charge-coupled device and an image output line is additionally mounted on the motherboard. The large-sized motherboard is separable from the monitor shell so only the monitor shell located on the outside of the car body is affected by the heat. As a result, the lifetime of the car-use camera can be extended. Besides, only the monitor shell may be taken away when the car-use camera suffers from thievery. Consequently, the risk of being taken away can be reduced.

The aforementioned objects and advantages of the present invention will be readily clarified in the description of the preferred embodiments and the enclosed drawings of the present invention.

### BRIEF DESCRIPTION OF THE DRAWINGS

FIG. 1 is a three-dimensional view of a preferred embodiment of the present invention.

FIG. 2 is a three-dimensional, exploded view of the devices of the preferred embodiment of the present invention.

FIG. 3 is a schematic view showing the practical usage of the preferred embodiment of the present invention.

FIG. 4 is a three-dimensional, exploded view of the devices of the conventional structure.

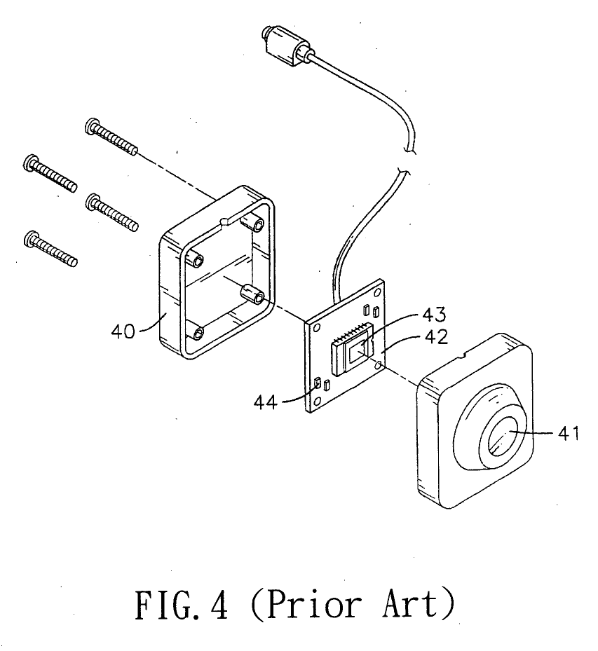

FIG. 5 is a schematic view showing the practical usage of the conventional structure.

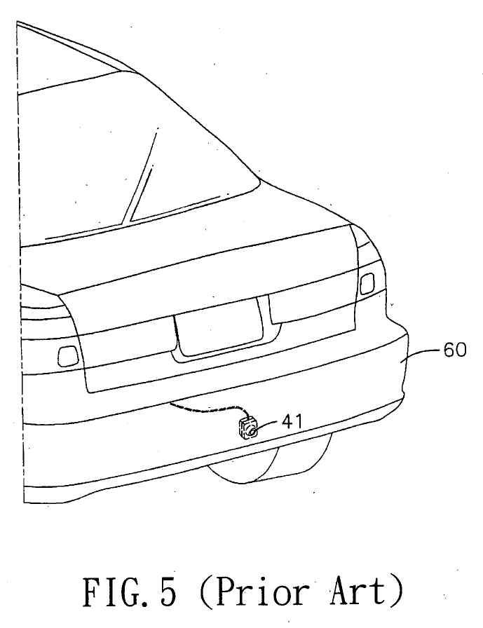

### DETAILED DESCRIPTION OF THE PREFERRED EMBODIMENT

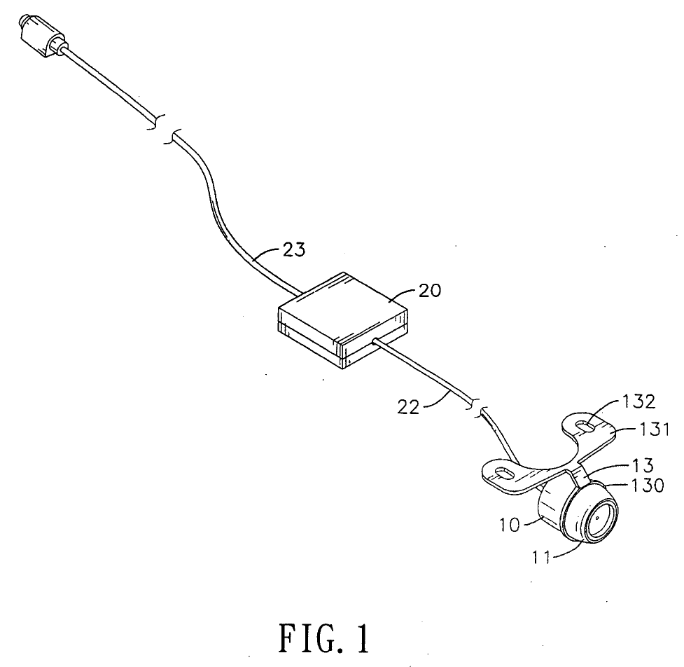

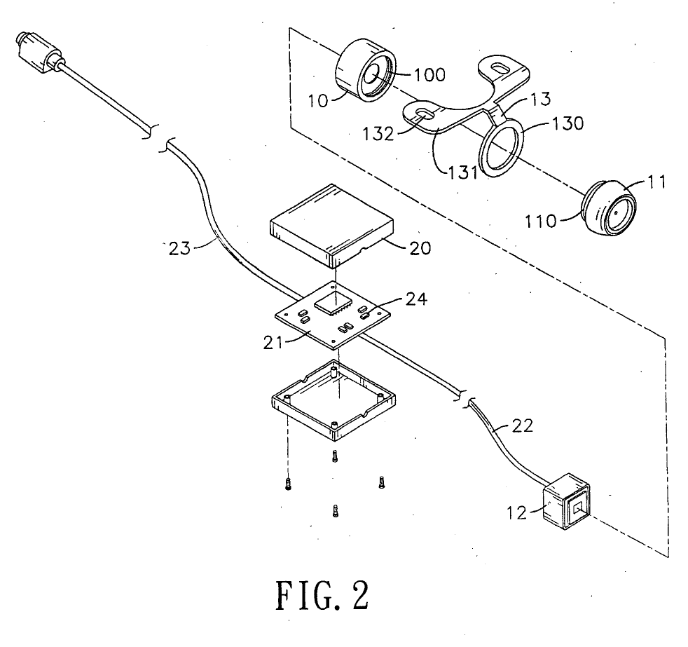

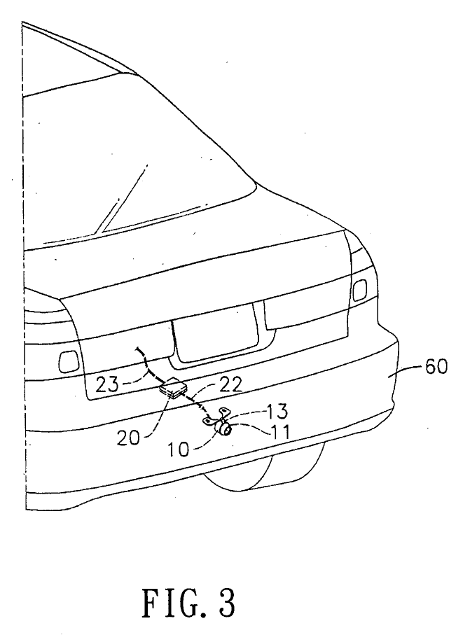

Referring to FIG. 1 through FIG. 3, a car-use camera of the present invention comprises a monitor shell 10, a motherboard shell 20, and a fixing device 13.

A monitor lens 11 is mounted on the outside of the monitor shell 10, and a charge-coupled device 12 is mounted on the inside of the monitor shell 10.

A motherboard 21 having peripheral circuits 24 is mounted on the inside of the motherboard shell 20. A transmission line 22 is mounted to connect the motherboard 21 with the charge-coupled device 12, wherein an image output line 23 is additionally mounted on the motherboard 21.

The fixing device 13 is mounted between the monitor shell 10 and the monitor lens 11 for fixing the car-use camera on a car bumper 60, under a handle of car trunk, or on any proper position of car body, for example.

The monitor shell 10 is in the shape of a cylinder, wherein several inner threads 100 are mounted on one end of the monitor lens 11. Several outer threads 110 are mounted on one end of the monitor lens 11 to engage with the inner threads 100 such that the monitor lens 11 can be coupled with the monitor shell 10. In addition, the fixing device 13 is provided with a fixing ring 130, wherein the fixing ring 130 is designed to be located between the assembled monitor shell 10 and monitor lens 11. A fixing plate 131 having two fixing holes 132 is integrally extended from one side of the fixing ring 13, wherein the fixing plate 131 is designed to securely screw the monitor shell 10 and the monitor lens 11 onto the car bumper 60 by penetrating two locking devices such as bolts or screws through the fixing holes 132.

The motherboard shell 20 can be mounted, for example, on the inside of the car trunk apart from the car bumper 60. In addition, the motherboard 21 is electrically connected to the charge-coupled device 12 located inside the monitor shell 10 via the transmission line 22.

The large-sized motherboard 21 is separated from the monitor shell 10 so only the small-sized and anti-heat monitor shell 10 is mounted on the car bumper 10. As a result, the lifetime of the car-use camera can be extended since the high temperature will not affect the motherboard 21. Besides, the monitor lens 11 has small size so it can be attached to the car bumper 60 easily. For the same reason, only the cheap and unusable monitor shell 10 may be taken away when the car-use camera suffers from thievery. In other words, the thief cannot take the expensive motherboard 21 away. Consequently, the loss of the car owner and the thieving desire of the thief are both reduced.

In summary, the present invention discloses a car-use camera that has extended lifetime and reduced loss of thievery. Accordingly, the present invention satisfies patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A car-use camera comprising:
a monitor shell having a monitor lens on the outside thereof and a charge-coupled device on the inside thereof; and
a motherboard shell having a motherboard having peripheral circuits on the inside thereof, wherein a transmission line is located to electrically connect the motherboard and the charge-coupled device and an image output line is additionally mounted on the motherboard.

2. The car-use camera of claim 1, wherein the monitor shell is in the shape of a cylinder and has a plurality of inner threads on one end, and wherein a plurality of outer threads are mounted on one end of the monitor lens to engage with the inner threads.

3. The car-use camera of claim 1, wherein a fixing device is mounted on the outside of the monitor shell for fixing the car-use camera on a car body.

4. The car-use camera of claim 3, wherein the monitor shell is in the shape of a cylinder and has a plurality of inner threads on one end, and wherein a plurality of outer threads are mounted on one end of the monitor lens to engage with the inner threads.

5. The car-use camera of claim 4, wherein the fixing device has a fixing ring located between the assembled monitor shell and monitor lens, and wherein a fixing plate having at least a fixing hole is integrally extended from one side of the fixing ring.

6. The car-use camera of claim 1, wherein a fixing device is mounted on the outside of the monitor shell for fixing the car-use camera under a handle of a car trunk.

7. The car-use camera of claim 6, wherein the monitor shell is in the shape of a cylinder and has a plurality of inner threads on one end and a plurality of outer threads are mounted on one end of the monitor lens to engage with the inner threads.

8. The car-use camera of claim 7, wherein the fixing device has a fixing ring located between the assembled monitor shell and monitor lens, and wherein a fixing plate having at least a fixing hole is integrally extended from one side of the fixing ring.
